(19) United States
(12) Patent Application Publication
(10) Pub. No.: US 2026/0255154 A1
(43) Pub. Date: Aug. 27, 2026

(54) SUBNETWORK FORMATION AND REGISTRATION

(71) Applicant: Apple Inc., Cupertino, CA (US)

(72) Inventors: Dimitrios Alanis, Munich (DE); Christian Hofmann, Munich (DE); Sameh M. Eldessoki, Munich (DE); Panagiotis Botsinis, Munich (DE); Anousheh Gholami Ghavamabad, San Diego, CA (US); Tarik Tabet, San Jose, CA (US)

(73) Assignee: Apple Inc., Cupertino, CA (US)

(21) Appl. No.: 19/251,685

(22) Filed: Jun. 26, 2025

(30) Foreign Application Priority Data
Feb. 26, 2025 (GR) 20250100149

(51) Int. Cl. H04W 8/24; H04W 4/06; H04W 60/00

(52) U.S. Cl. CPC H04W 8/24; H04W 4/06; H04W 60/00

(57) ABSTRACT

The present application relates to devices and components, including apparatus, systems, and methods for the formation, management, and operation of subnetworks within device-to-device (D2D) communication environments.

### CROSS-REFERENCE TO RELATED APPLICATION

This application claims the benefit of Greece Patent Application No. 20250100149, filed on Feb. 26, 2025, the contents of which are incorporated herein by reference in its entirety for all purposes.

### TECHNICAL FIELD

This application relates generally to communication networks and, in particular, to the formation, management, and operation of subnetworks (SNs) within device-to-device (D2D) communication environments.

### BACKGROUND

Third Generation Partnership Project (3GPP) Technical Specifications (TSs) define standards for wireless networks. These TSs describe aspects related to user plane and control plane signaling over the networks.

Subnetworks, commonly referred to as subnets, are subdivisions of a larger network, often created to improve network efficiency, manageability, and security. They allow a network to be divided into smaller, logically defined sections, enabling better control over data flow and resource allocation. This segmentation reduces network congestion by limiting broadcast traffic to within each subnet and enhances security by isolating sensitive parts of the network from unauthorized access.

In wireless and mobile communication environments, subnetworks enable localized communication between nearby devices without relying on a central network infrastructure. This is particularly important in scenarios such as disaster recovery, remote areas with limited network coverage, or applications requiring low-latency communication. Subnetworks also facilitate load balancing, where traffic is distributed across different segments to prevent bottlenecks, and enhance scalability by allowing networks to expand incrementally without overwhelming the central network. By providing a flexible and modular approach to network design, subnetworks are a foundational concept in modern communication systems.

### BRIEF DESCRIPTION OF THE DRAWINGS

FIG. 1 illustrates a network environment in accordance with some embodiments.

FIG. 2 illustrates a network topology in accordance with some embodiments.

FIG. 3 illustrates another network topology in accordance with some embodiments.

FIG. 4 illustrates a timing and signaling diagram in accordance with some embodiments.

FIG. 5 illustrates another timing and signaling diagram in accordance with some embodiments.

FIG. 6 illustrates another timing and signaling diagram in accordance with some embodiments.

FIG. 7 illustrates another timing and signaling diagram in accordance with some embodiments.

FIG. 8 illustrates another timing and signaling diagram in accordance with some embodiments.

FIG. 9 illustrates an operation flow/algorithmic structure in accordance with some embodiments.

FIG. 10 illustrates another operation flow/algorithmic structure in accordance with some embodiments.

FIG. 11 illustrates an operation flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

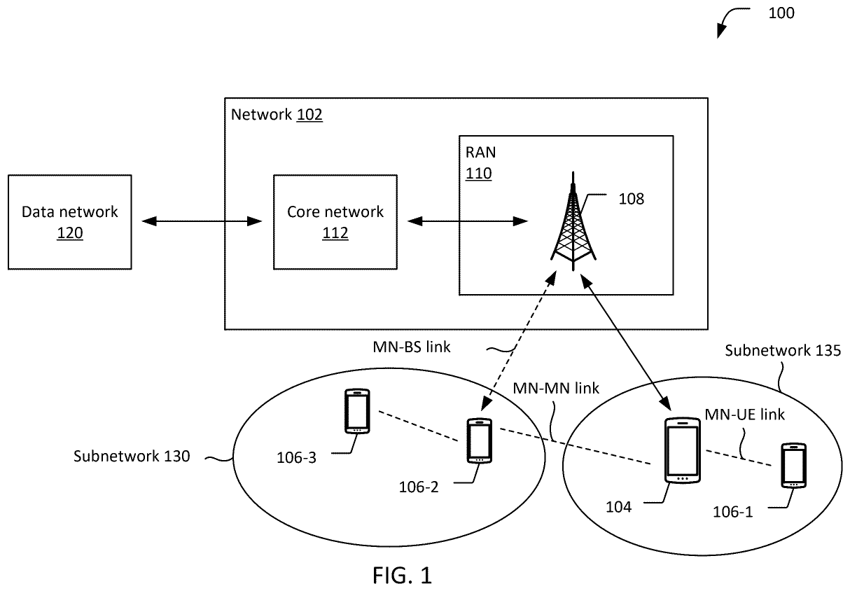

FIG. 1 illustrates a network environment 100 in accordance with some embodiments. The network environment 100 may include a UE 104 communicatively coupled with a base station (BS) 108 of a radio access network (RAN) 110. The UE 104 and the base station 108 may communicate over air interfaces compatible with 3GPP TSs, such as those that define a Fifth Generation (5G) new radio (NR) system, a Sixth Generation (6G) system, or a later system. The base station 108 may provide user plane and control plane protocol terminations toward the UE 104.

Operations described herein as associated with devices of the network environment 100 (for example, the UE 104 and the base station 108) may be fully, substantially, or partially performed by processor circuitry of the device.

The network environment 100 may further include a core network 112. For example, the core network 112 may comprise a 5th Generation Core network (5GC) or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions. The core network 112, RAN 110, and RAN 110 may collectively be referred to as network 102.

The network environment 100 may further include a data network 120. Data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

In some instances, some UEs, e.g., UEs 106-1 or 106-3, are not directly reachable by the BS 108, motivating the formation of subnetworks, e.g., subnetworks 130 and 135, to enable localized communication among UEs and providing a link to connect the unreachable UEs to the network 102. This can occur in situations such as areas with limited BS coverage, high-density environments where direct BS communication is inefficient, or when UEs move out of coverage zones. By forming subnetworks, these UEs can maintain connectivity through device-to-device (D2D) communication, providing communication links even in the absence of a direct connection to the BS 108. Subnetworks 130 and 135 may allow UEs 106-1 or 106-3 to communicate efficiently within their vicinity while also enabling them to access the broader network through intermediary nodes, e.g., the UE 104 or 106-2.

To manage the operation of subnetworks, the role of a management node (MN) is introduced. The MN may act as the central coordinator within a subnetwork, facilitating communication between the UEs and, where possible, providing connectivity to the BS 108 or other subnetworks. An MN is typically a UE with superior computational power, higher battery capacity, and robust connectivity capabilities, which may include direct access to the BS 108 or links to other MNs in neighboring subnetworks. Additionally, the MN may be capable of performing tasks such as resource allocation, scheduling communication, and ensuring the overall stability of the subnetwork. The presence of an MN may also allow low-capability UEs within the subnetwork to offload computation on the MN. For example, the UE 104 may be a MN in subnetwork 135 and the UE 106-2 may be the MN in subnetwork 130. Low capability (LC) UE 106-3 in subnetwork 103 may be connected to network 102 through high capability (HC) UE 106-2. Similarly, in subnetwork 135, the LC UE 106-1 may be connected to HC UE 104 via an MN-UE link. The MN-UE link may be a D2D link.

In some instances, the communication link between MN and BS 108 may fail or may not exist. For example, the MN-BS link between the UE 106-2 and the BS 108 may fail or may not exist. In this scenario, the UEs in subnetwork 130 may connect to network 102 through the MN-MN link connecting the MN of subnetwork 130, e.g., the UE 106-2, to the MN of subnetwork 135, e.g., the UE 104.

The criteria for forming subnetworks may be designed to provide connectivity for all UEs. Subnetworks are formed based on adjacency information, where UEs in close proximity evaluate their ability to communicate and determine the most suitable MN. The selection of the MN may be influenced by predefined properties, including battery life, computation power, and connectivity to the overlay network or other MNs. Furthermore, subnetworks must satisfy additional criteria to ensure functional performance, such as maintaining connectivity to at least one other subnetwork, balancing the load across MNs, and preserving privacy and trust among participating UEs. By adhering to these criteria, subnetworks may provide seamless connectivity and efficient communication for UEs, even in challenging network conditions or coverage-limited environments.

In some embodiments, UEs may form a subnetwork via a decentralized operation. In decentralized operation, UEs independently evaluate their internal states, capabilities, and adjacency information to identify and select a management node (MN) without relying on a centralized entity. Each UE may assess its suitability to become an MN based on predefined criteria such as computational power, battery level, and connectivity. For example, UEs with higher computational and connectivity capabilities may volunteer to become MNs and broadcast their intent to neighboring UEs. If a more capable MN emerges, UEs may choose to connect to it or continue monitoring for active MNs. This decentralized approach may allow subnetworks to be dynamically formed and managed based on local conditions, allowing UEs to maintain communication and adapt to changing scenarios, such as battery depletion or mobility.

In some embodiments, UEs may form a subnetwork through a centralized operation. In centralized operation, the selection of an MN and the formation of subnetworks are coordinated by a centralized control node, referred to as the Subnetwork Formation Control (SNFC) node. UEs exchange their capabilities and adjacency information with the SNFC, which constructs a network topology map and optimally determines the MNs for each subnetwork. The SNFC may use optimization algorithms or heuristics to ensure that the subnetworks satisfy various criteria, such as resource availability, load balancing, and MN-MN delay constraints (e.g., the maximum communication delay between MNs within a network remains within a predefined threshold). For example, the SNFC may select a UE with the maximum communication links or available resources as the MN and assign other UEs to subnetworks accordingly. This centralized approach may enable more efficient subnetwork formation in scenarios where global network optimization is required.

In some embodiment, UEs may form a subnetwork with the aid of the BS 108 using an anonymized approach. In this approach, the BS 108 may act as an information broker, facilitating the exchange of anonymized temporary identifiers and capability information among UEs to extend the communication range and support subnetwork formation. In some embodiments, the BS 108 may actively participate in the subnetwork formation process but merely assists in overcoming limitations of D2D communication, such as range constraints. For example, UEs that are out of direct communication range, e.g., the UE 106-3 and 106-1, may rely on the BS 108 to share their temporary identifiers and capability information with trusted users in other subnetworks. This approach may provide or preserve privacy by anonymizing the identifiers and prevents the BS 108 from having visibility into the actual identities or structure of the subnetworks.

In some embodiment, UEs may initiate subnetwork operations by registering the formed subnetwork with an overlay network. The registration procedure may allow the MN to inform the BS 108 about the existence of the subnetwork and its members, enabling the allocation of communication resources for the subnetwork. For example, an MN, e.g., the UE 104, may act as the intermediary, registering the subnetwork, e.g., subnetwork 135, with the BS 108 and receiving resource assignments that are distributed among the UEs within the subnetwork, e.g., the UE 104 or 106-1. In cases where the MN lacks a direct link to the BS, the registration may occur via an MN-MN link that connects the MN of one subnetwork to another MN with access to the BS. This registration process may allow the subnetwork to operate seamlessly within the broader network environment 100.

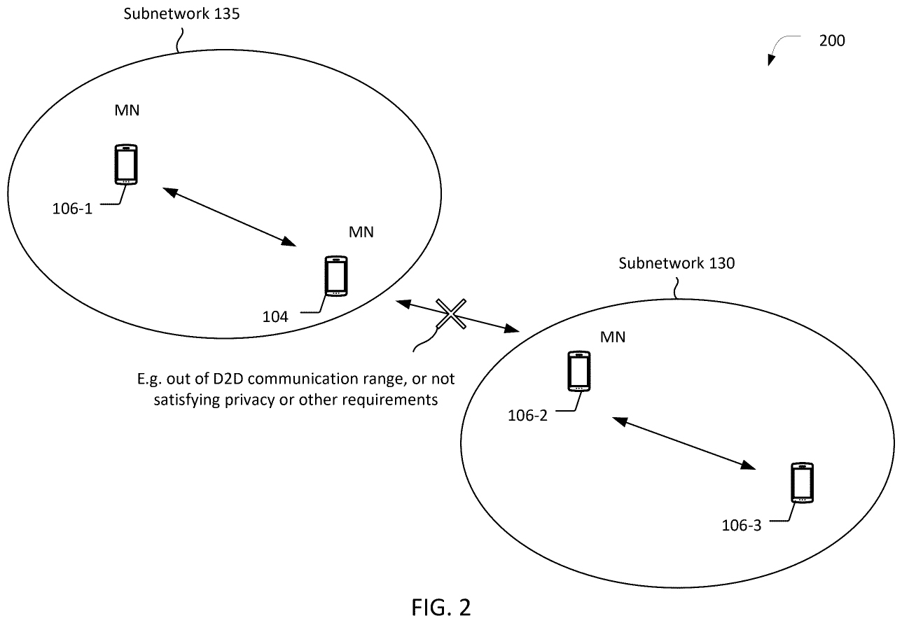

FIG. 2 illustrates a network topology 200 in accordance with some embodiments. FIG. 2 illustrates an example network environment where UEs form disconnected subnetworks to overcome limitations in D2D communication range, privacy constraints, or other operational requirements. In the depicted scenario, the network environment includes two subnetworks 130 and 135, each managed by an MN. Subnetwork 130 is managed by the UE 106-2, and subnetwork 135 is managed by the UE 104.

A subnetwork is formed when UEs within close proximity establish communication links and are not able to maintain direct connectivity with other UEs, that are not in the subnetwork, or the BS 108. For example, UEs in Subnetwork 130 or 135 may be out of D2D communication range or may not satisfy privacy requirements to communicate directly, necessitating the formation of separate subnetworks.

The figure highlights the role of MNs in managing subnetworks. Each MN is a high-capability UE that coordinates communication within its subnetwork and, where possible, connects to other subnetworks or the BS 108 to provide broader network access. For instance, the UE 106-2 with superior computational power, higher battery capacity, and robust connectivity capabilities, may assume the role of MN in the subnetwork 130, while another such UE, e.g., the UE 104, may take on the MN role in the subnetwork 135. The MNs may facilitate inter-subnetwork communication when possible, addressing challenges such as limited D2D range and resource optimization.

Additionally, FIG. 2 underscores the challenges and motivations for subnetwork formation. In some instances, UEs may need to consume significant power to communicate over longer distances, as seen in cases where UEs 106-2 may require higher transmission power to connect with distant node 106-1. By forming subnetworks, these UEs can reduce power consumption and maintain efficient communication within their subnetwork.

Subnetworks also address scenarios where UEs are entirely out of range of the BS 108, providing a mechanism for localized communication while still enabling broader network access through intermediary nodes, such as MNs that connect to other subnetworks or the BS 108.

FIG. 2 also highlights the importance of privacy requirements in forming and operating subnetworks. In some instances, UEs may choose to form subnetworks to limit information sharing to trusted devices within their immediate vicinity, thereby preserving user privacy. For example, the UE 106-1 in subnetwork 135 may only share its adjacency information or communication capabilities with other UEs within the same subnetwork, subject to privacy constraints. This may prevent sensitive data, such as location or device identity, from being exposed to UEs outside the subnetwork or the broader network infrastructure. Privacy-preserving communication mechanisms, such as the use of anonymized temporary identifiers, may further enhance security by preventing unauthorized tracking or interception of communication. These privacy requirements are particularly critical in scenarios where UEs operate in environments with limited trust or in applications where user confidentiality is paramount, such as enterprise networks or secure communication systems. Subnetworks can provide a secure and trusted communication environment while maintaining connectivity by adhering to these privacy constraints.

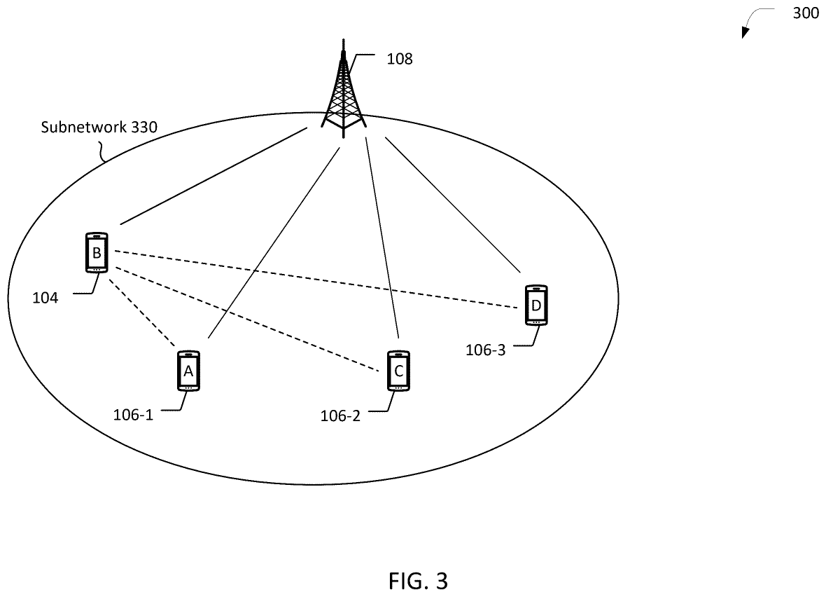

FIG. 3 illustrates another network topology 300 in accordance with some embodiments. Network topology 300 is an example of a single subnetwork 330 that can be utilized to overcome the limitations of D2D communication and achieve broader connectivity. In this scenario, subnetwork 330 may leverage communication links between UEs and base station 108, which is provided by an overlay network, to extend the reach of its UEs. This approach may enable UEs within the subnetwork 330, e.g., UEs 104, or 106 1-3, to communicate with external entities, such as other subnetworks or the network 102, even when direct communication paths to the BS 108 are not feasible or require large amounts of resources such as power. By utilizing communication link of UE 104 with the BS 108, the subnetwork 330 may provide all its UEs, including those with low capabilities or out of communication range with the BS 108, connectivity to the broader network environment.

The mechanisms demonstrated in this scenario can also be applied to a network topology, e.g., the network topology 200 in FIG. 2, where multiple connected or disconnected subnetworks exist. For example, in a topology with subnetworks 130 and 135 in FIG. 2, which are isolated due to D2D range or privacy limitations, an overlay network, such as one facilitated by the BS 108, can act as an intermediary to bridge the communication gap. Subnetworks can utilize the radio access network of the overlay network to discover and establish communication with each other. In this context, the BS 108 may act as an information broker, sharing anonymized temporary identifiers and capability information between the subnetworks, enabling broader connectivity while preserving privacy. This ensures that initially disconnected subnetworks can form an interconnected network, allowing for resource sharing and improved communication efficiency.

In some instances, the BS 108 may support subnetwork communication by facilitating the extension of the communication range. The BS 108 may help UEs within a subnetwork access broader network resources and services. Similarly, in a multi-subnetwork topology, the BS may provide a backbone that links multiple subnetworks, enabling them to remain connected even when direct D2D communication is not possible. The BS 108 role may remain limited to that of an information broker, ensuring privacy by anonymizing UE identifiers and restricting its visibility into the subnetwork's internal structure.

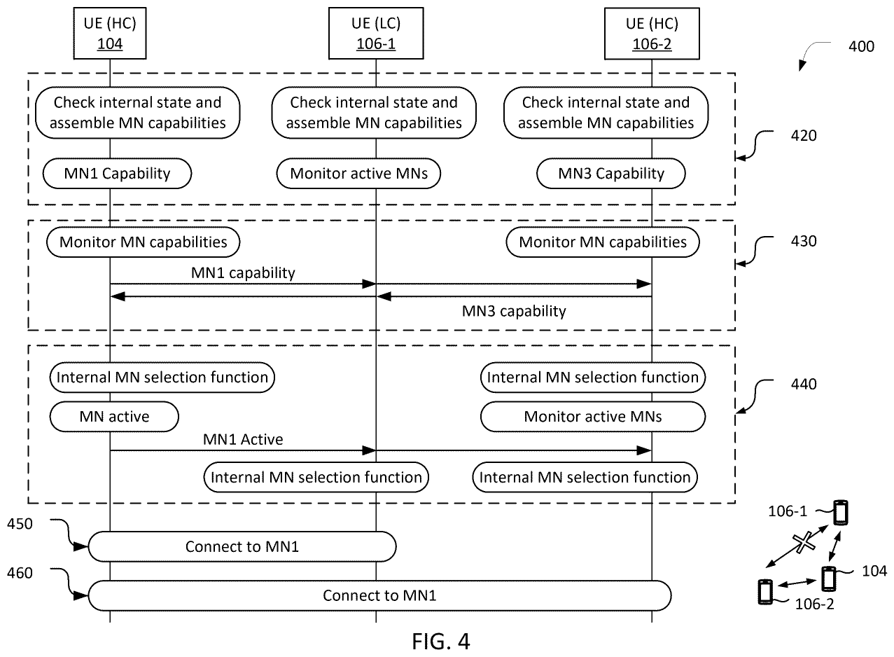

FIG. 4 illustrates an operation and signaling diagram 400 in accordance with some embodiments. A network environment with three UEs, UE 104, UE 106-1, and UE 106-2, is considered and the operation and signaling diagram 400 illustrates and example process of subnetwork formation. The process of subnetwork formation may include three key operations: MN Capabilities Report Creation, MN Capabilities Exchange, and MN Selection. UE 104 and 106-2 are high-capability (HC) UEs, while UE 106-1 is a low-capability (LC) UE. The network connectivity topology shows that UE 104 is in communication range to both UE 106-1 and 106-2, but there is no direct communication link between UE 106-1 and UE 106-2. This topology highlights the need for an MN to facilitate connectivity and communication within the subnetwork. The operations are performed in a distributed manner, with each UE contributing based on its capabilities and state.

The first operation 420 is “MN Capabilities Report Creation,” where each UE evaluates its internal state and assembles a report of its management node capabilities. In some embodiments, only HC UEs, e.g., UE 104 and UE 106-2, may assemble MN capabilities. For example, the HC UEs may identify an indication that the UE is an HC UE and assemble MN capabilities based on such indication. The management capability report may include information such as the UE identifier (ID), adjacency information, communication capabilities, computational capabilities, and functional offloading services. These capabilities are assessed to determine whether a UE is suitable to become an MN or if it should connect to an existing MN. These communication metrics ensure that the MN can manage the subnetwork's communication requirements effectively. High-capability UEs, such as UE 104 or UE 106-2, may actively create MN capabilities reports, while low-capability UEs, such as UE 106-1, may monitor for active MNs to decide to which one it connects.

Adjacency information is a component of the MN capabilities report. It refers to the list of neighboring UEs with which a given UE can directly communicate. This information may be gathered during the discovery and authentication phase, where each UE identifies its neighbors based on factors such as temporary IDs, authentication status (e.g., whether the neighbor is authenticated), or signal strength. For example, UE 104 may identify UEs 106-1 and 106-2 as its neighbors, while UE 106-1 may only recognize UE 104 as their direct connection or neighbor. To preserve privacy, some UEs may choose to limit the sharing of their adjacency information, ensuring that only direct neighbors are aware of their connections. For example, a UE may prohibit its trusted neighbors from sharing its information with other UEs. This approach may protect sensitive data, such as neighborhood relationships, while still enabling the formation of subnetworks. In some embodiments, even when two UEs are in communication range of one another, they may not establish a trust relationship, and in the absence of a trust relationship or consent, they may not include one another in their list of neighboring UEs.

Communication capabilities may describe the UE's ability to establish and maintain communication links. These capabilities include metrics such as the type of connection to the overlay network (e.g., Long-Term Evolution (LTE), NR, 6G, or non-terrestrial network (NTN)), the number of component carriers supported, the round-trip time (RTT) to the BS 108, and the UE's mobility state. For instance, UE 104, with a stable connection to BS 108 and support for multiple component carriers, may be well-equipped to handle communication tasks as an MN.

Computational capabilities may refer to the resources available within a UE to support subnetwork operations. This may include the memory allocated for subnetwork use, the number of floating-point operations per second (FLOPs) available, and the battery energy reserved for subnetwork tasks. High-capability UEs, such as UE 104 and UE 106-2, may possess substantial computational resources, making them suitable candidates for the MN role. For example, UE 104 may have sufficient memory and processing power to handle resource allocation and scheduling tasks for a subnetwork.

Functional offloading services describe the specific applications and tasks a UE can support within the subnetwork. These services may include standalone UE functionality, compute offloading, coordinated measurements, or mobility functions. For instance, UE 104 may support compute offloading, allowing it to process computationally intensive tasks on behalf of other UEs in the subnetwork. This capability enhances the overall efficiency of the subnetwork and further strengthens UE 104's suitability as an MN.

In a subnetwork, the classification of a UE as an HC UE is not static and can change dynamically based on the internal state of the UE. Factors such as battery status, computational load, and connectivity capabilities can influence whether a UE remains classified as HC or transitions to an LC state. For example, an HC UE serving as an MN may experience a significant depletion in battery power, making it unsuitable to continue its role as an MN. In such a scenario, the UE may relinquish its MN responsibilities and transition to a regular UE role within the subnetwork. Similarly, if a UE's internal resources, such as memory or processing power, are diverted to other tasks or reduced due to hardware or software constraints, it may no longer meet the criteria for an HC classification. Conversely, an LC UE can potentially transition to an HC state if its internal conditions improve, such as through battery recharging, resource optimization, or enhanced connectivity. This fluid classification system ensures that the subnetwork adapts dynamically to changing conditions, maintaining efficient operation and resource allocation by selecting the most suitable UEs to act as MNs at any given time. This adaptability is critical for ensuring the resilience and sustainability of the subnetwork, particularly in environments where UEs experience fluctuating resource availability.

The second operation 430 is “MN Capabilities Exchange,” where UEs that have volunteered to become MNs may broadcast their capabilities and intent to become MN to their neighboring UEs. UE 104 and UE 106-2, as potential MNs, may share their capabilities with one another and with UE 106-1. For example, UE 104 may send it management node capability report, e.g., the “MN1 Capability” message, to UEs 106-1 or 106-2, allowing them to evaluate its suitability as an MN. Similarly, UE 106-2 may generate and send its management capability report to both UE 104 and UE 106-1. This operation may allow all potential MNs to collect capability reports from neighboring UEs and that all UEs are aware of the available MN options. The MN capabilities exchange process is dynamic and occurs periodically to adapt to changes in the environment, such as mobility or resource depletion.

Since the system is dynamic, this phase may be periodically active for a certain duration (e.g., every X seconds (periodicity) for a duration of Y seconds). For instance, the exchange of capability messages may be aligned with the cellular time grid or GNSS timing to ensure synchronization among devices. These parameters, such as the frequency and duration of the exchange, can be preconfigured by the system or agreed upon during the discovery phase among the UEs. This periodic activity may allow the network to remain flexible and responsive to changes in the internal state of the UEs, such as shifts in battery power, computational resources, or connectivity conditions. By enabling regular updates, the most suitable UEs are selected as MNs and the subnetwork may remain stable and efficient under dynamic conditions.

The operation 440 is “MN Selection,” where each UE uses an internal function to determine whether it should become an MN or connect to an existing MN. This decision is based on the MN capabilities exchanged during the previous operation, as well as the UE's internal state and application requirements. For example, UE 106-1, being a low-capability UE, may evaluate the capabilities of UE 104 and UE 106-2 and determine that UE 104 is the most suitable MN for connection. UE 104, after analyzing its adjacency information and capabilities and the adjacency and management capability report of the UE 106-2, may confirm its role as the MN. Meanwhile, UE 106-2 may determine that UE 104 is better suited as an MN, e.g., due to its connectivity to the UE 106-1 and the UE 106-2, and decides not to assume the MN role. Once the MN selection operation 440 is complete, UE 104 may broadcast a message indicating its “MN1 Active” status to neighboring UEs, formally establishing itself as the MN for the subnetwork.

In operation 440, the internal function executed by each UE may take as input the received set of MN capability reports, the set of applications and requirements derived from the UE's internal state, and the adjacency information collected during the discovery and exchange phases 430. The model used to evaluate these inputs may vary and may include deterministic models, heuristic approaches, or advanced machine learning models, such as deep neural networks. The output of this internal function may determine whether the UE should become an MN or not. For example, based on the adjacency information, there may be UEs that are only visible to one potential MN, such as UE 106-1 being visible only to UE 104. In this case, UE 104 would assume the role of the MN to ensure connectivity for all UEs in the subnetwork.

Additionally, the internal function may generate a priority list of MNs for each UE, ranking potential MNs based on the UE's internal state and the capabilities of the active MNs. This priority list may vary between UEs depending on their individual requirements and local conditions. Each UE may attempt to connect to MNs in the order of their priority list, though such connection attempt may be rejected by the MNs if resource constraints or other limitations prevent additional connections. For example, if UE 106-1 and UE 106-2 both prioritize UE 104 as their MN, UE 104 may evaluate these connection requests and accept them based on its available resources.

Once MN selection is finalized, MNs broadcast their MN status, including their MN capabilities, to inform neighboring UEs of their active role. For instance, UE 104 may broadcast its “MN1 Active” status to UE 106-1 and UE 106-2, confirming its role as the MN for the subnetwork. Following this, UEs that are not MNs, such as UE 106-1 and UE 106-2, may attempt to establish connections with the selected MN, e.g., at operations 450 or 460. The subnetwork is fully formed when UEs are connected to a suitable MN.

This distributed process may enable the dynamic formation of subnetworks and is managed based on the local conditions and capabilities of the UEs. The system is designed to adapt to changes such as mobility, resource depletion, or the addition of new UEs, ensuring efficient and reliable communication within the subnetwork. This approach may enable seamless subnetwork formation and operation in diverse and dynamic network environments by leveraging decentralized decision-making and privacy-preserving mechanisms.

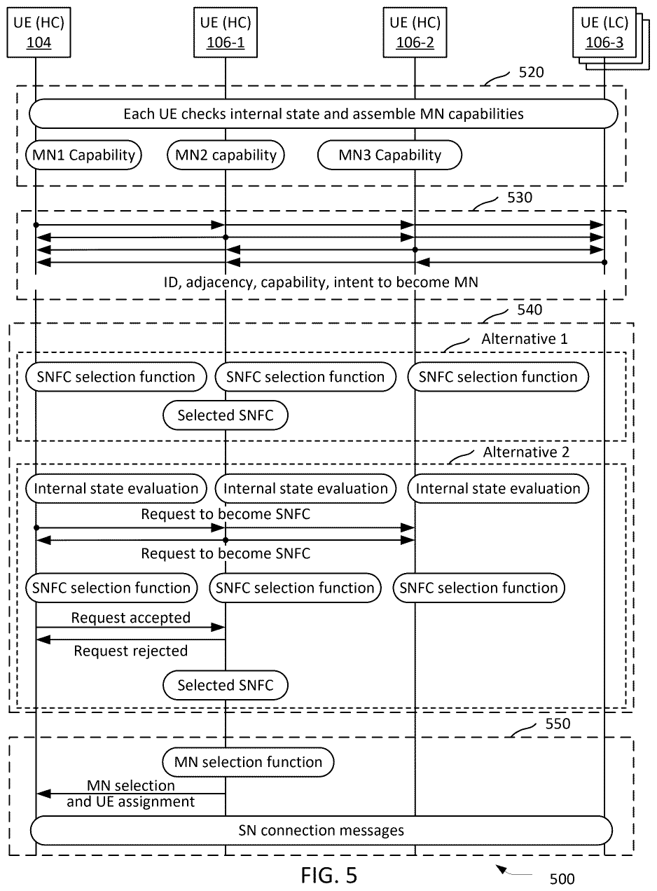

FIG. 5 illustrates another operation and signaling diagram 500 in accordance with some embodiments. The operation and signaling diagram 500 is an example of a centralized UE-centric subnetwork formation. In centralized UE-centric subnetwork formation, the process is coordinated by a central control node referred to as the SNFC node. This node is selected from among the HC UEs based on their capabilities and suitability to act as a central coordinator. Once selected, the SNFC node may perform tasks such as constructing a network topology map, selecting MNs for the subnetwork, and assigning UEs to appropriate MNs. All UEs, including HC UEs such as UE 104, UE 106-1, and UE 106-2, and LC UEs like UE 106-3, are assumed to be within communication range of one another. This global communication capability allows the SNFC node to make centralized decisions based on a comprehensive view of the network, providing resource allocation, load balancing, and connectivity management. Centralized subnetwork formation may progress through four main operations: Capabilities Creation, Capability Exchange and Network Topology Map Creation, SNFC Selection, and MN Selection and SN Formation.

The first operation 520, Capabilities Creation, may be similar to the operation 420. Each UE may evaluate its internal state and assemble a management capability report of its management node capabilities. This report may include essential information such as the UE ID, adjacency information, communication capabilities, computational capabilities, and functional offloading services. Each UE may generate a unique identifier (UE ID) and collect adjacency information, which may describe the list of neighboring UEs with which direct communication is possible. For example, UE 104 may identify UE 106-1, UE 106-2, and UE 106-3 as its direct neighbors, enabling it to construct a local view of the network topology. The report may also include communication capabilities, such as the number of component carriers supported, RTT to the base station, and connection type (e.g., LTE, NR, 6G, or NTN). For instance, UE 104, with its robust connectivity and low RTT, may demonstrate superior communication capabilities. Additionally, the report may capture computational capabilities, including memory size, battery power, and processing capacity (e.g., FLOPs), which make UEs like UE 104 and UE 106-1 well-suited for computationally intensive tasks. Finally, UEs may list functional offloading services they can support, such as compute offloading, mobility functions, or coordinated measurements. For example, UE 104 may provide compute offloading services, enabling other UEs to delegate computationally demanding tasks to it. These detailed reports form the foundation for making informed decisions in subsequent operations.

The second operation, 530, Capability Exchange and Network Topology Map Creation, may involve UEs sharing their capabilities with one another to construct a comprehensive network topology map. Each UE may broadcast its capability report to its neighbors using standardized messages, such as “SN_capability_and_topology_control” messages. For instance, UE 104 may share its capabilities with UE 106-1, UE 106-2, and UE 106-3, while the other UEs follow a similar process. This exchange may ensure that all UEs are aware of the resources and capabilities available at other UEs. Based on the received capability reports, each UE may construct and maintain an adjacency matrix that represents the network topology. For example, UE 104 may create a matrix indicating its direct connections to UE 106-1, UE 106-2, and UE 106-3 while noting the connections between other UEs. The topology map may be updated periodically or in response to events, reflecting the current state of the network. This operation may provide all UEs a global view of the network, which may be used to select the SNFC node.

The third operation 540, SNFC Selection, determines which UE will act as the SNFC node. This node is responsible for coordinating the formation of the subnetwork by selecting MNs and assigning UEs to these MNs. SNFC selection can occur in two ways. A first alternative may include a deterministic approach in which each UE independently may execute an SNFC selection function using criteria such as computational power, battery level, and connectivity. For example, the UE with the maximum available resources or the highest number of communication links is selected as the SNFC. This may provide a non-conflicting selection process where all UEs agree on the chosen SNFC. A second alternative may include a negotiation-based approach in which UEs that volunteer to become the SNFC node send proposals to other UEs. A negotiation phase follows, during which the volunteering UEs evaluate each other's proposals and agree on the most suitable candidate. For instance, UE 104 may propose itself as the SNFC node to UE 106-1 and UE 106-2, and based on its superior capabilities, it may be confirmed as the SNFC. Once selected, the SNFC node may take control of the subnetwork formation process, leveraging its global knowledge of the network topology and capabilities to make centralized decisions.

The fourth operation 550, MN Selection and SN Formation, may involve the SNFC node executing the process of selecting MNs for the subnetwork and assigning UEs to these MNs. This operation may use inputs such as the network topology map, device capabilities, and a set of properties derived from application requirements.

The SNFC node may determine which UEs should act as MNs by evaluating the network topology map, device capabilities, and application-driven properties, such as MN network connectivity and survivability, MN-MN delay constraint, load balancing, privacy constraints, and resource constraints. For example, MN network connectivity and survivability may require that each MN be connected to at least m other MNs, where m is a predefined threshold. If m equals 1, each subnetwork may maintain connectivity to at least one other subnetwork. If m equals 2, the network of MNs may survive a single MN failure, allowing inter-subnetwork communication to persist even when one MN fails or shuts down. This property may support robust subnetwork operation under failure conditions.

The MN-MN delay constraint may restrict the maximum communication delay between MNs, facilitating efficient coordination and timely communication between them. This constraint may be particularly important for applications that require low-latency communication or inter-subnetwork collaboration.

Load balancing may require that the formed MNs distribute their responsibilities evenly in terms of population and resources. This approach may prevent resource bottlenecks and avoid overloading any single MN. Privacy constraints may further dictate that a minimum trust level must exist for all pairs of nodes in the subnetwork, limiting communication to trusted peers. Resource constraints may specify that a certain combination or amount of resources—either individually or collectively within the subnetwork—must be available to meet the requirements of applications supported by the subnetwork.

The SNFC node may use advanced techniques to solve the subnetwork formation problem, including optimization-based solutions, heuristic approaches, approximation techniques, or machine learning-based models. For instance, the SNFC node may model the subnetwork formation problem as a Team Formation Problem, where the objective is to form subnetworks that satisfy all predefined properties while optimizing performance and resource utilization. Such models may allow the SNFC node to derive an optimal or near-optimal solution for selecting MNs and assigning UEs.

Once the SNFC node selects the MNs, it may notify them about their assigned UEs. For example, UE 106-1, acting as the SNFC node, may select itself and UE 104 as MNs due to their high capabilities and central positions in the network topology. The SNFC node may then assign each UE to a specific MN to connect all UEs to the subnetwork. For instance, UE 106-3, being an LC UE, may be assigned to UE 104, while UE 106-2 may also connect to UE 104 based on proximity and resource availability. The assignments may account for all properties, such as balancing the load across MNs and maintaining the required connectivity and delay constraints.

After the MNs are selected and UEs are assigned, the MNs may broadcast their status and capabilities to their assigned UEs. For instance, UE 104 may broadcast a message indicating its “MN1 Active” status to UE 106-3 and UE 106-2, confirming its role as their MN. Similarly, UE 106-1 may broadcast its “MN2 Active” status to its assigned UEs. These messages may allow the UEs to finalize their connections to the selected MNs, completing the subnetwork formation process.

The SN connection messages may be transmitted between the MNs and their assigned UEs, establishing communication links within the subnetwork. For example, UE 106-3 and UE 106-2 may establish D2D communication links with UE 104, while UEs assigned to UE 106-1 may establish similar links with their MN. This hierarchical structure may organize the subnetwork for efficient communication and support interactions between the MNs and their assigned UEs.

This operation may form the subnetwork in a manner that satisfies all application-driven requirements, such as survivability, delay constraints, and resource availability. By leveraging the global view of the network and employing advanced modeling techniques, the SNFC node may optimize the formation of subnetworks to deliver reliable, efficient, and scalable communication in diverse network environments. The process may also adapt dynamically to changes such as mobility, resource depletion, or the addition of new UEs, maintaining the operational functionality and efficiency of the subnetwork over time.

The centralized subnetwork formation process may provide several advantages, including efficient resource allocation, improved load balancing, and enhanced connectivity. By relying on a single SNFC node with a global view of the network to coordinate the process, the decisions are made based on a comprehensive view of the network, rather than localized conditions. This approach is particularly beneficial in scenarios where all UEs are within communication range, as it enables seamless coordination and management of the subnetwork. Additionally, the centralized approach supports dynamic adjustments to changes in the network, such as mobility, resource depletion, or the addition of new UEs, ensuring that the subnetwork remains efficient and reliable over time.

The centralized UE-centric subnetwork formation process is also applicable to non-fully connected networks, where not all UEs are within direct communication range of one another. In such cases, the capability exchange and topology map creation operation may require several rounds of adjacency information exchanges to ensure that all nodes receive information from all other nodes in the network. For instance, UEs that are not directly connected can rely on intermediary UEs to forward their capabilities and adjacency data, gradually building a comprehensive topology map over multiple iterations. This iterative process may enable the SNFC node to obtain a global view of the network despite the presence of communication gaps. While this approach introduces additional overhead due to the repeated exchanges, it may extend the centralized formation process to more complex network topologies, maintaining its benefits of optimized resource allocation, load balancing, and efficient subnetwork formation even in partially connected or fragmented network environments.

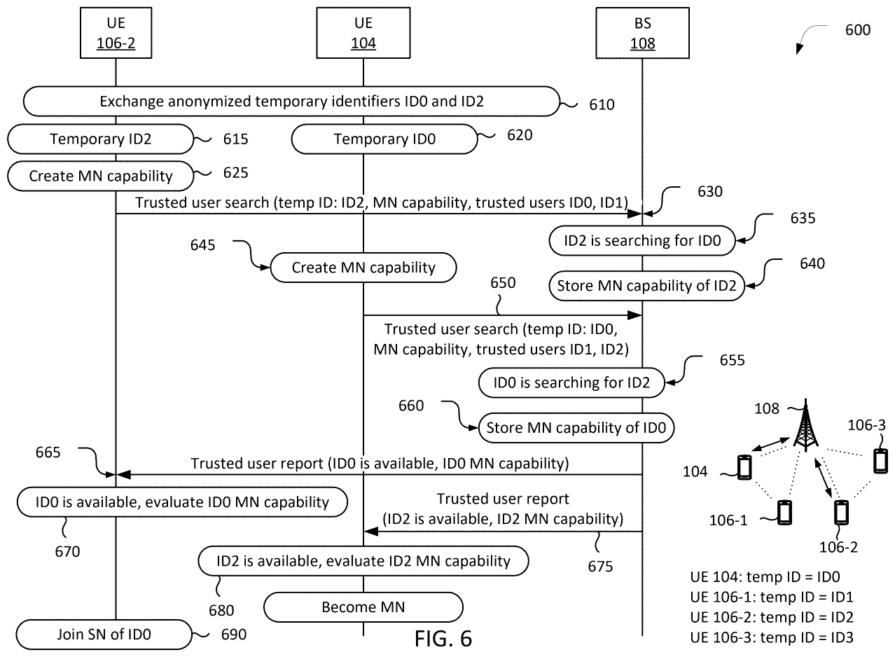

FIG. 6 illustrates another operation and signaling diagram 600 in accordance with some embodiments. In this operation, the BS 108 may facilitate a BS-aided subnetwork formation process. The BS-aided subnetwork formation applies to topologies where UEs are not directly connected via D2D communication or in fully connected networks. The assumed topology is depicted in FIG. 6, it is assumed that the UE 104 and UE 106-1 are within communication range of each other and connected to the BS 108, while UE 106-2 and UE 106-3 are similarly within range of one another and also connected to the BS 108. The BS 108 may play a role in bridging this gap by facilitating the exchange of information between these disconnected UEs, enabling the formation of a subnetwork despite the absence of direct communication links.

The process begins a 610 with the discovery and exchange of anonymized identifiers to preserve privacy. Each UE may generate a temporary identifier (Temporary ID). For example, at 615, UE 106-2 generates Temporary ID 2, while UE 104 generates Temporary ID 0, at 620. These temporary identifiers anonymize the UEs, allowing their identities to remain private while exchanging information.

At 625, the UE 106-2, for instance, may initiate the process by creating a management node capability report. The management node capability report may be a management node capability information element (MN Capability IE).

At 630, the UE 106-2 may generate a search message containing its Temporary ID 2. This search message is sent to the BS 108, indicating that UE 106-2 is searching for other UEs, such as UE 104. The search message may include a list of trusted users, e.g., the UE 104, or UE 106-1 by indicating their Temporary IDs.

At 635, based on the search message, the BS 108 may determine that the UE associated with Temporary ID 2 (e.g., the UE 106-2) is searching for the UE associated with the Temporary ID 0 (e.g., the UE 104).

The BS 108 may act as an intermediary in this process, storing and managing the MN Capability IEs and temporary identifiers received from the UEs, e.g., at 640. For example, at 640, the BS 108 stores the Temporary ID 2 and MN Capability IE of UE 106-2

At 645, UE 104 may generate its own MN Capability IE.

At 650, the UE 104 may send a search message to the BS 108, including its Temporary ID 0. This search message is sent to the BS 108, indicating that UE 104 is searching for other UEs, such as UE 106-2. The search message may include a list of trusted users, e.g., the UE 106-1, or UE 106-2 by indicating their Temporary IDs.

At 655, based on the search message, the BS 108 may determine that the UE associated with Temporary ID 0 (e.g., the UE 104) is searching for the UE associated with the Temporary ID 2 (e.g., the UE 106-2).

At 660, the BS 108 may store the Temporary ID 0 and MN Capability IE of UE 104.

The BS 108 then may identify a match between the search messages received from the UEs. For instance, the BS 108 may recognize that UE 106-2 is searching for UE 104 and vice versa. Once a match is identified, at 665, the BS 108 may send a trusted user report to UE 106-2, indicating that UE 104 (Temporary ID 0) is available and may provide the UE 104's MN Capability IE. Similarly, at 675, a trusted user report may be sent to UE 104, informing it of UE 106-2's availability (Temporary ID 2) and sharing UE 106-2's MN Capability IE.

At 670 and 680, after receiving the trusted user reports, the UEs evaluate the MN Capability IEs to determine their respective roles within the subnetwork. For instance, at 670, the UE 106-2 may evaluate the MN Capability IE of UE 104 and may decide to join the subnetwork managed by UE 104 if it determines that UE 104 has superior capabilities, such as higher computational power, better connectivity, or greater battery resources. Similarly, at 680, UE 104 may evaluate the MN Capability IE of UE 106-2 and confirm its suitability. This decision-making process is dynamic and is based on the capabilities exchanged through the BS 108, allowing the subnetwork formation based on the specific conditions and requirements of the participating UEs.

The BS-aided subnetwork formation process is also designed to adapt to changes in the network environment. The BS 108 may periodically update the temporary identifiers and MN Capability IEs of the UEs to reflect changes in their internal states, such as battery depletion, computational resource availability, or mobility. This periodic update may allow the subnetwork to remain responsive to the evolving needs of its participants. Additionally, the use of temporary identifiers may allow all exchanged information to be anonymized, preventing unauthorized tracking or exposure of sensitive data.

Once the subnetwork is formed, the UEs may establish communication within the subnetwork and, where possible, with the broader network through the BS 108. For example, UE 106-2, after joining the subnetwork managed by UE 104, may communicate with UE 104 over a D2D link and access the broader network via UE 104's connection to the BS 108.

This BS-aided subnetwork formation process elaborates the role of the BS 108 as an intermediary and facilitator. By managing the exchange of temporary identifiers and MN Capability IEs, the BS 108 enables UEs in separate clusters to discover one another and coordinate their roles within the subnetwork.

The BS-aided subnetwork formation process described may include several considerations to provide privacy, flexibility, and adaptability for enhancing the effectiveness of the approach and addressing specific challenges in subnetwork formation.

First, in some instances, the process may assume that devices intending to share a subnetwork have pre-established trust levels among one another. This precondition allows only trusted UEs to participate in the subnetwork formation process, safeguarding the integrity of the network. For instance, prior to initiating the BS-aided subnetwork formation, UEs such as UE 104 and UE 106-2 are assumed to have aligned on trust-related parameters, allowing them to securely exchange temporary identifiers and management node capability information elements (MN Capability IEs). This trust may prevent sensitive information to be shared with unauthorized devices and may prevent malicious attacks, such as man-in-the-middle attacks.

Second, the BS-aided subnetwork formation process may be equivalent to the decentralized subnetwork formation process but with the added benefit of leveraging the BS 108 to extend communication range. In scenarios where UEs are out of D2D communication range, the BS 108 may act as an intermediary to facilitate the exchange of information. For example, while UE 104 and UE 106-2 are unable to communicate directly, the BS 108 enables their interaction by sharing their MN Capability IEs and temporary identifiers. This extension of communication range may enable UEs in separate clusters to form a subnetwork, even when direct links are unavailable. Importantly, the BS 108 may serve as an information broker in this process and may not participate in the subnetwork formation or operation itself, preserving the decentralized nature of the subnetwork.

Finally, the BS-aided subnetwork formation process can also be implemented in a centralized manner, where the BS 108 takes on additional responsibilities, such as selecting the Subnetwork Formation Control (SNFC) node. In such an implementation, the BS 108 would aggregate the capabilities and adjacency information of all UEs in its coverage area and use this global view to designate the SNFC node. For example, the BS 108 might evaluate the resources and connectivity of UEs such as UE 104 and UE 106-2 and select the most suitable UE as the SNFC node to coordinate the subnetwork formation. This centralized approach may be beneficial in scenarios requiring greater control or optimization of subnetwork formation, particularly when UEs lack the capability to make decentralized decisions effectively.

By incorporating these considerations, the BS-aided subnetwork formation process may enable UEs to securely and efficiently form subnetworks, even in challenging environments with limited D2D connectivity. The pre-established trust levels among UEs, the BS's role as an information broker, and the potential for centralized coordination may contribute to a robust and adaptable subnetwork formation mechanism. These features may further enhance the ability of the system to maintain privacy, scalability, and operational efficiency across diverse network conditions.

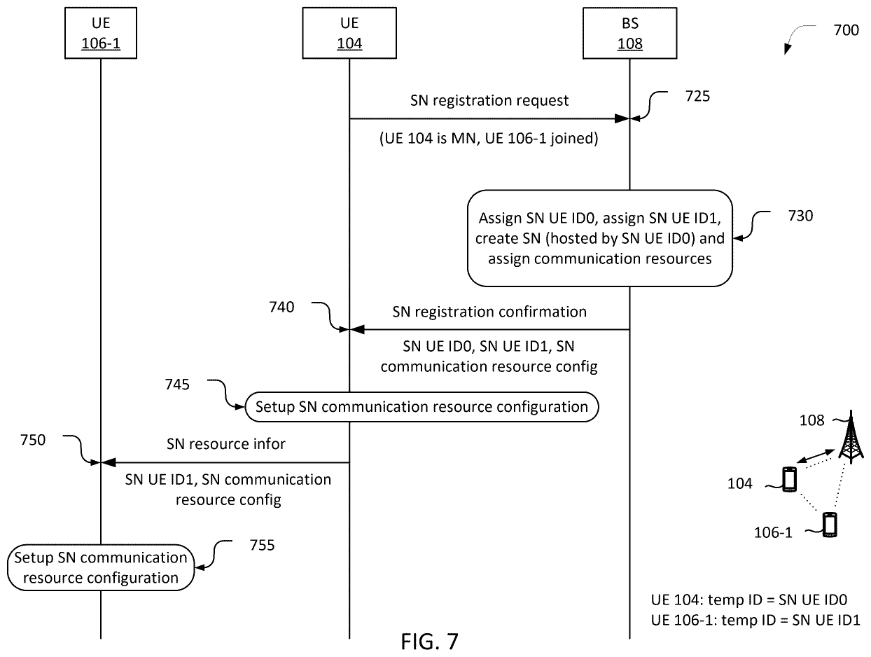

FIG. 7 illustrates another operation and signaling diagram 700 in accordance with some embodiments. In this operation, the topology consists of UE 104 and UE 106-1, where UE 104 has a direct D2D communication link with UE 106-1 and is also connected to the BS 108. However, UE 106-1 is out of the range of BS 108 and cannot directly communicate with it. In this configuration, UE 104 has assumed the MN role for the subnetwork, and UE 106-1 has joined the subnetwork associated with UE 104. The figure describes the steps involved in registering the subnetwork with BS 108 and configuring the communication resources for the UEs.

The process begins at 725 with UE 104 acting as the MN and initiating the registration of the subnetwork with BS 108. UE 104 may generate a subnetwork registration request message that includes details about the subnetwork, such as its unique identifier and the list of members, including UE 106-1. This registration request is sent from UE 104 to BS 108, informing the BS that UE 106-1 has joined the subnetwork managed by UE 104.

At 730, upon receiving this request, BS 108 processes the information and may create a subnetwork information block that includes the subnetwork's unique identifier and details about the communication resources to be allocated to the subnetwork.

The BS 108 may assign identifiers and resources to the subnetwork and its members. For example, BS 108 may assign a subnetwork identifier (SN ID) to the subnetwork managed by UE 104, as well as individual identifiers for UE 104 and UE 106-1 within the subnetwork, e.g., SN UE ID0 to UE 104 and SN UE ID1 to UE 106-1. Additionally or alternatively, BS 108 may allocate radio access network communication resources for the subnetwork, such as spectrum or time slots, that will be used for communication between the MN and its associated UEs.

At 740, the allocation of resources by the BS 108 is communicated back to UE 104 in the form of a subnetwork registration confirmation message, which includes the assigned SN ID, the individual identifiers for the UEs, and the configuration details for the communication resources.

At 745, after receiving the registration confirmation from BS 108, UE 104 begins configuring the communication resources for the subnetwork. UE 104 may set up subnetwork communication resource configuration and distribute the resource configuration to its associated UE, UE 106-1, over the established D2D link.

At 750, the UE 104 may send subnetwork information to the UE 106-1. For example, the UE 104 may inform UE 106-1 about its assigned identifier within the subnetwork and the specific communication parameters it should use when communicating with the MN. This operation may allow UE 104 and UE 106-1 to align on the communication protocols and resource usage.

At 755, the UE 106-1 may set up subnetwork communication resource configuration.

In some instances, once the configuration is complete, the subnetwork may become operational, with UE 104 acting as the MN and managing communication between the subnetwork and BS 108. For example, UE 106-1 can now use the communication resources allocated by BS 108 to communicate with UE 104 over the D2D link, while UE 104 serves as the intermediary for any communication between UE 106-1 and the broader network via BS 108. This hierarchical structure may allow UE 106-1 to access network services and resources despite being out of range of BS 108, leveraging the connection of UE 104 to the BS.

The subnetwork registration and configuration process described in operation and signaling 700 shows the role of the MN in facilitating communication for UEs that lack direct connectivity to the BS. By acting as the intermediary, the MN may allow UEs like UE 106-1 to participate in the subnetwork and access broader network resources while the BS allocates and configures the necessary communication resources to support the subnetwork. This process may enable the subnetwork to operate and maintain connectivity in scenarios where some UEs are beyond the direct reach of the BS.

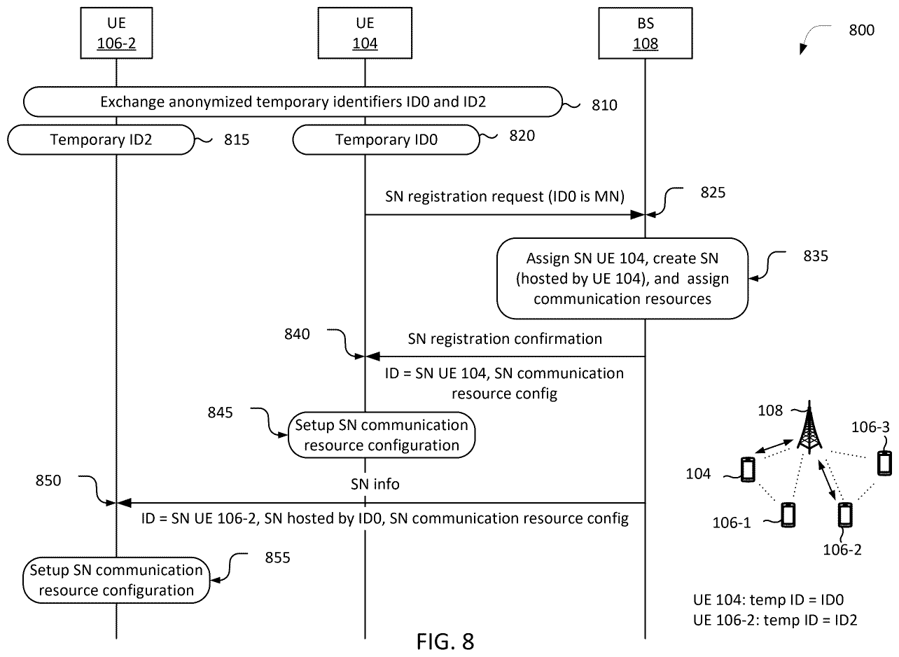

FIG. 8 illustrates another operation and signaling diagram 800 in accordance with some embodiments. In this operation, the topology consists of UE 104 and UE 106-1, which are within communication range of each other and connected to the base station (BS 108). Similarly, UE 106-2 and UE 106-3 are within communication range of each other and are also connected to BS 108. However, there is no direct D2D communication link between the first pair of UEs (UE 104 and UE 106-1) and the second pair (UE 106-2 and UE 106-3). The figure outlines the operation involved in the registration of the subnetworks with BS 108 and the configuration of communication resources for the UEs in their respective subnetworks.

The operations at 810, 815, and 820, for example, are similar to those performed at 610, 615, and 620 described in FIG. 6.

At 825, the UE 104, acting as the MN, may initiate the registration of its subnetwork with BS 108. UE 104 may generate a subnetwork registration request message that identifies itself as the MN and indicates the formation of a subnetwork. This request is sent to BS 108, informing the BS of the subnetwork's existence and the need for resource allocation. The registration request primarily focuses on the connection between UE 104 and BS 108 while also enabling communication with UE 106-2 and UE 106-3 through the BS.

At 835, upon receiving the registration request from the UE 104, the BS 108 may process the information and creates a subnetwork information block for the subnetwork. This block may include a unique identifier for the subnetwork and the allocation of communication resources to support communication within the subnetwork. For example, BS 108 assigns a subnetwork identifier (SN ID) to the subnetwork hosted by UE 104 and allocates specific communication resources, such as spectrum or time slots, for communication between UE 104 and UE 106-1.

At 840, the BS 108 may communicate the results of the registration process back to UE 104 in the form of a subnetwork registration confirmation message. This message may include the assigned SN ID and configuration details for the allocated communication resources. For instance, the confirmation may include parameters to be used for D2D communication between UE 104 and UE 106-1, allowing both UEs to establish coordinated communication within the subnetwork.

At 845, after receiving the registration confirmation, UE 104 may begin configuring the communication resources for its subnetwork. As described above in FIG. 7, over the established D2D link, UE 104 may provide UE 106-1 with the resource configuration details, including its assigned parameters for communication within the subnetwork.

At 850, the BS 108 may communicate the registration process results to UE 106-2 in the form of a subnetwork information message. This message may include the assigned SN ID to the UE 106-2, indicating that the subnetwork is hosted by UE with Temporary ID 0, e.g., the UE 104, and configuration details for the allocated communication resources. For instance, the confirmation may include parameters to be used for D2D communication between UE 106-2 and UE 106-3, allowing both UEs to establish coordinated communication within the subnetwork.

At 855, after receiving the registration confirmation, UE 106-2 may begin configuring the communication resources for its subnetwork. In a process similar to the one described above in FIG. 7, UE 106-2 may provide UE 106-3 with the resource configuration details, including its assigned parameters for communication within the subnetwork.

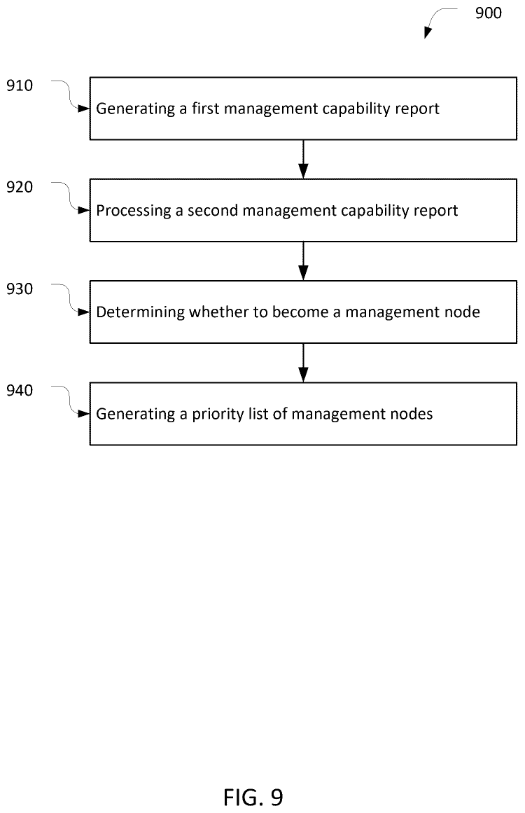

FIG. 9 illustrates an operation flow/algorithmic structure 900 in accordance with some embodiments. The operation flow/algorithmic structure 900 may be performed or implemented by a UE such as, for example, the UE 104, the UE 106-1-3, or UE 1200; or components thereof, for example, baseband processor circuitry 1204A.

The operation flow/algorithmic structure 900 may include, at 910, generating a management capability report. The first management capability report. The management capability report is associated with the UE 104 and may include a UE ID, adjacency information, a communication capability, a computational capability, or a list of services. In some embodiments, the management capability report may indicate an intent to become a management node.

The operation flow/algorithmic structure 900 may include, at 920, processing a management capability report. The management capability report may be received by the UE 104 and transmitted by another UE, e.g., the UE 106-1, 2, or 3, or the base station 108, and may be associated with the UE 106-1, 2, or 3.

The operation flow/algorithmic structure 900 may include, at 930, determining whether to become a management node. The receiving UE, e.g., UE 104, may use the information in its own management capability report and management capability report(s) received from other UE(s) to determine the management node.

In some embodiment, the receiving UE, e.g., the UE 104, may determine to be the management node. Operation 900 may further include generating a management node status and outputting the management node status for a broadcast transmission. The management node status may indicate that the UE 104 became the management node.

The operation flow/algorithmic structure 900 may include, at 930, generating a priority list of management nodes. The priority list may indicate the priority associated with each selected management node. A UE may first request a connection with the MN associated with the highest priority in its list. If the MN rejects the connection request, the UE may send the connection request to the next MN on the list.

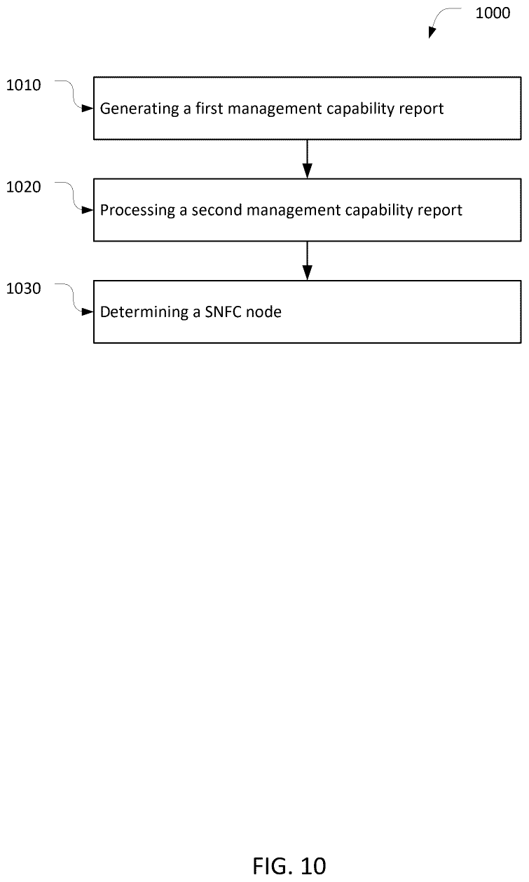

FIG. 10 illustrates an operation flow/algorithmic structure 1000 in accordance with some embodiments. The operation flow/algorithmic structure 1000 may be performed or implemented by a UE such as, for example, the UE 104, the UE 106-1-3, or UE 1200; or components thereof, for example, baseband processor circuitry 1204A.

The operation flow/algorithmic structure 1000 may include, at 1010, generating a first message capability report. The operation at 1010 is, for example, similar to the operation at 910 in FIG. 9.

The operation flow/algorithmic structure 1000 may include, at 1020, processing a management capability report. The operation at 1020 is, for example, similar to the operation at 920 in FIG. 9.

The operation flow/algorithmic structure 1000 may include, at 1030, determining an SNFC node. In some embodiments, the SNFC node is determined based on the execution of an SNFC selection function. In some embodiments, the SNFC node is determined based on a negotiation phase among the volunteering nodes to become the SNFC.

In some embodiments, the operation 1000, may include constructing an adjacency matrix. The adjacency matrix may represent a network topology. The adjacency matrix may be updated periodically, or an event may trigger updating the adjacency matrix.

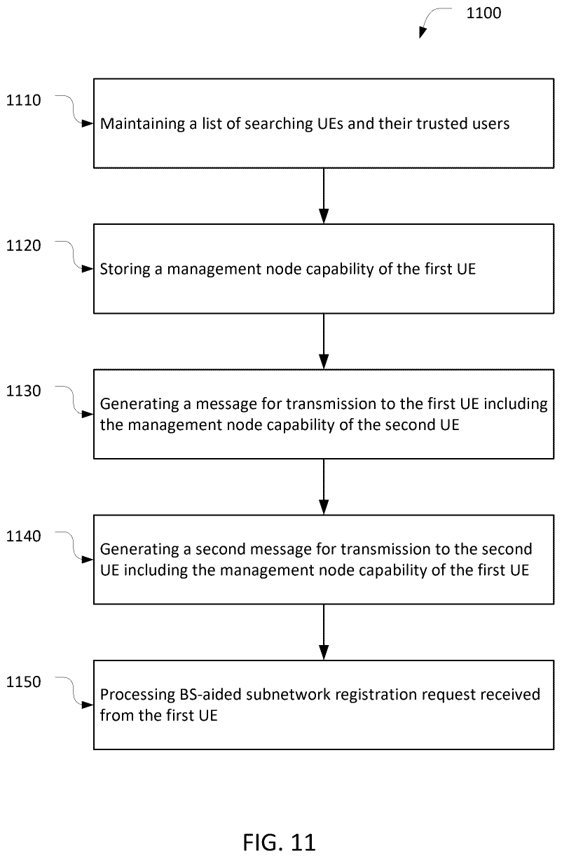

FIG. 11 illustrates an operational flow/algorithmic structure 1100 in accordance with some embodiments. The operation flow/algorithmic structure 1100 may be performed or implemented by a base station such as, for example, the base station 108 or the base station 1300; or components thereof, for example, baseband processor circuitry 1304A.

The operation flow/algorithmic structure 1100 may include, at 1110, maintaining a list of searching UEs and their trusted users. The list may associate each UE with the temporary identifiers of its trusted UEs. For instance, if UE 104 and UE 106-2 have pre-established a trust relationship, this is reflected in the list maintained by the BS 108. The list may include an entry indicating that UE 104 (Temporary ID 0) is associated with UE 106-2 (Temporary ID 2) as a trusted UE. This trust relationship is a precondition for enabling the BS 108 to act as an information broker, facilitating the exchange of management node capability information elements (MN Capability IEs) between the UEs without compromising privacy.

When the BS 108 processes the search messages from UE 104 and UE 106-2, it may reference the list to identify matches between UEs based on their trust relationships. For example, the BS 108 may identify that UE 104 is searching for a trusted UE and that UE 106-2 matches this criterion. The BS 108 may then provide each UE with the temporary identifier and capability information of the other UE via trusted user reports. In this case, UE 104 may receive a report indicating that UE 106-2 (Temporary ID 2) is available, along with its MN Capability IE, while UE 106-2 may receive a similar report about UE 104 (Temporary ID 0).

By maintaining this list, the BS 108 may enable UEs to discover and connect with their trusted peers in a privacy-preserving manner. The list allows that only UEs with pre-established trust relationships to exchange information and form subnetworks. This mechanism is particularly important in scenarios where UEs are out of D2D communication range but can still establish connections through the BS 108 as an intermediary. The use of temporary identifiers further enhances privacy by anonymizing the UEs during the discovery and connection process. This approach supports the formation of secure and efficient subnetworks in environments with limited direct connectivity.

The operation flow/algorithmic structure 1100 may include, at 1120, storing a management node capability of the first UE.

The operation flow/algorithmic structure 1100 may include, at 1130, generating a message including the management node capability of the second UE.

The operation flow/algorithmic structure 1100 may include, at 1140, generating a message including the management node capability of the first UE.

The operation flow/algorithmic structure 1100 may include, at 1150, processing BS-aided subnetwork registration request received from the first UE.

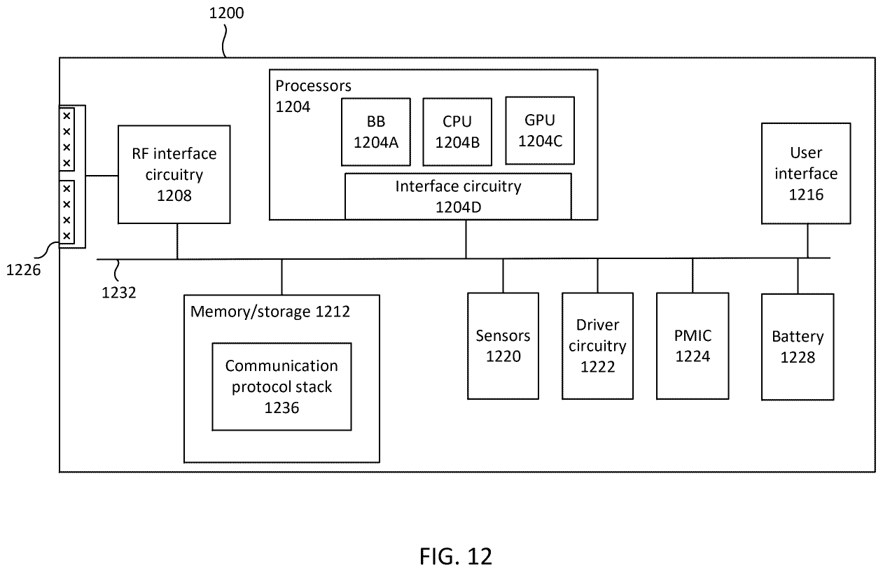

FIG. 12 illustrates a UE 1200 in accordance with some embodiments. The UE 1200 may be similar to and substantially interchangeable with the UE 104.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein. The processors 1204 may also include interface circuitry 1204D to communicatively couple the processor circuitry with one or more other components of the UE 1200.

In some embodiments, the baseband processor circuitry 1204A may access a communication protocol stack 1236 in the memory/storage 1212 to communicate over a 3GPP-compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within or connected to the UE 1200. For example, driver circuitry 1222 may include a display driver to control and allow access to a display device, a touchscreen driver to control and allow access to a touchscreen interface, sensor drivers to obtain sensor readings of sensors 1220, and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples, the UE 1200 may be mounted deployed in a fixed location and may have a power supply coupled to an electrical grid. The battery 1228 may be a lithium-ion battery, a metal-air battery, such as a zinc-air battery, an aluminum-air battery, a lithium-air battery, and the like. In some implementations, such as in vehicle-based applications, the battery 1228 may be a typical lead-acid automotive battery.

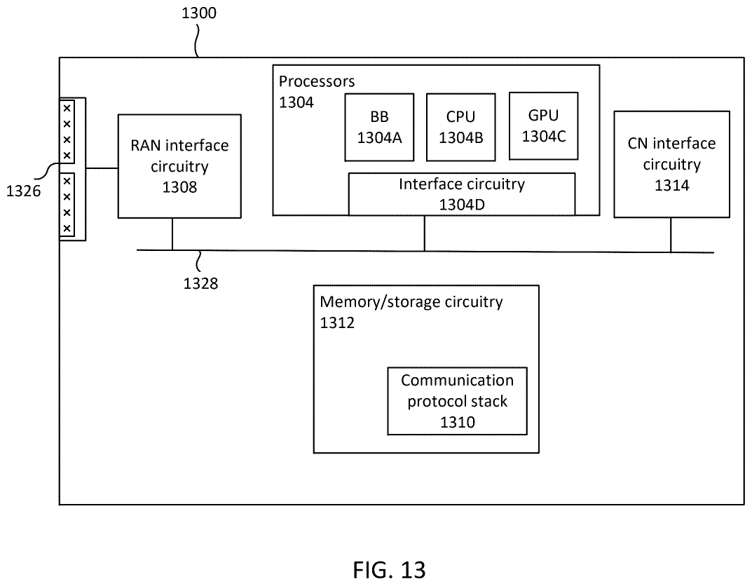

FIG. 13 illustrates a network device 1300 in accordance with some embodiments. The network device 1300 may be similar to and substantially interchangeable with base station 108.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the UE 1200 to perform operations as described herein. The processors 1304 may also include interface circuitry 1304D to communicatively couple the processor circuitry with one or more other components of the network device 1300.

The CN interface circuitry 1314 may provide connectivity to a core network, for example, a 5th Generation Core network (5GC) using a 5GC-compatible network interface protocol such as carrier Ethernet protocols or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.
Example 1 includes a method including: generating, by a first node, a first management capability report associated with the first node to be transmitted to a second node; processing a second management capability report associated with the second node; determining, based on the first management capability report and the second management capability report, whether to become a management node; and generating a priority list of management nodes with which to connect.
Example 2 includes the method of example 1 or some other examples herein, wherein said determining whether to become a management node includes determining to become the management node, and the method further includes: generating a management node status based on said determining to become the management node; and outputting the management node status for a broadcast transmission to indicate that the first node became the management node.
Example 3 includes the method of any of examples 1-2 or some other examples herein, further including: processing a connection request received from the second node.
Example 4 includes the method of any of examples 1-3 or some other examples herein, further including: generating a subnetwork registration request for transmission to a base station.
Example 5 includes the method of any of examples 1-4 or some other examples herein, wherein the first management capability report includes: a user equipment (UE) identifier (ID); adjacency information; a communication capability; a computational capability; or a list of services.
Example 6 includes the method of any of examples 1-5 or some other examples herein, wherein the first management capability report comprises adjacency information, the adjacency information indicating: a list of neighbors including a list of temporary identifiers; authentication status information; or a measurement report.
Example 7 includes the method of any of examples 1-6 or some other examples herein, wherein the first management capability report comprises a communication capability to indicate: a type associated with a connection to a network; a number of supported component carriers; a round-trip time; or a mobility state.
Example 8 includes the method of any of examples 1-7 or some other examples herein, wherein the first management capability report comprises a computational capability to indicate: a size of memory allocated for a subnetwork use; a processing capability associated with a subnetwork use; or battery energy allocated for a subnetwork use.
Example 9 includes the method of any of examples 1-8 or some other examples herein, wherein the first management capability report comprises a list of services, the list of services indicating a list of functional offloading applications supported with a subnetwork.
Example 10 includes the method of any of examples 1-9 or some other examples herein, wherein the first management capability report indicates an intent to become a management node.
Example 11 includes the method of any of examples 1-10 or some other examples herein, further includes: identifying a schedule for exchanging management capability reports including a periodicity or a duration.
Example 12 includes the method of any of examples 1-11 or some other examples herein, wherein said determining to become a management node is based on a deterministic model, a heuristic model, or a machine-learning model.
Example 13 includes the method of any of examples 1-12 or some other examples herein, wherein the second management capability report is received from a base station.
Example 14 includes a method including: generating, by a first node, a first management capability report associated with the first node to be transmitted to a second node; processing a second management capability report associated with the second node; and determining, based on the first management capability report and the second management capability report, a subnetwork formation control (SNFC) node.
Example 15 includes the method of example 14 or some other examples herein, further including: constructing, based on the first management capability report and the second management capability report, an adjacency matrix representing a network topology.
Example 16 includes the method of any of examples 14 or 15 or some other examples herein, further including: updating, periodically or based on detecting an event, the adjacency matrix.
Example 17 includes the method of any of examples 14-16 or some other examples herein, wherein said determining an SNFC node includes: executing a SNFC selection function; or generating a request, to be transmitted to the second node, indicating an intent to become the SNFC node.
Example 18 includes the method of any of examples 14-17 or some other examples herein, wherein said determining an SNFC node includes determining that the first node is the SNFC node, and the method further includes: determining a management node by executing a management node selection function; and notifying the selected management node about one or more nodes assigned to a subnetwork associated with the selected management node.
Example 19 includes the method of any of examples 14-18 or some other examples herein, wherein said determining a management node is based on a network topology map, a device capability, or satisfying a condition.
Example 20 includes the method of any of examples 14-19 or some other examples herein, wherein said determining a management node is based on satisfying a condition, wherein the condition is satisfied when: a number of connections to other management nodes meets or exceeds a threshold; a communication delay with other management nodes is less than a threshold; a load balancing constraint is met; a privacy constraint is met; or a resource constraint is met.
Example 21 includes the method of any of examples 14-20 or some other examples herein, wherein the first node is the management node, and the method further includes: generating a subnetwork registration request for transmission to a base station; and generating a subnetwork connection message to be transmitted to the assigned nodes or other management nodes.
Example 22 includes a method including: maintaining a list including an indication of a first user equipment (UE) and temporary identifier of a second UE, wherein the second UE is a trusted UE of the first UE; storing a first management node capability of the first UE; generating a first message for transmission to the first UE, including a second management node capability of the second UE; generating a second message for transmission to the second UE including the first management node capability; and processing a base station (BS)-aided subnetwork registration request received from the first UE to register a subnetwork.
Example 23 includes the method of example 22 or some other examples herein, further including: generating subnetwork information for transmission to the second node, the subnetwork information indicating registration of the subnetwork or resources assigned to the subnetwork.

Another example may include an apparatus comprising means to perform one or more elements of a method described in or related to any of examples 1-23, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example may include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
generating, at a first node, a first management capability report associated with the first node, the first management capability report to be transmitted to a second node;
processing a second management capability report associated with the second node;
determining, based on the first management capability report and the second management capability report, to become a management node; and
generating, for broadcast transmission, a management node status based on said determining to become the management node.

2. The method of claim 1, further comprising:
processing a connection request received from the second node, wherein the connection request is based on a priority list.

3. The method of claim 1, further comprising:
generating a subnetwork registration request for transmission to a base station.

4. The method of claim 1, wherein the first management capability report comprises:
a user equipment (UE) identifier (ID);
adjacency information;
a communication capability;
a computational capability; or
a list of services.

5. The method of claim 1, wherein the first management capability report comprises adjacency information, the adjacency information indicating:
a list of neighbors including a list of temporary identifiers;
authentication status information; or
a measurement report.

6. The method of claim 1, wherein the first management capability report comprises:
a communication capability to indicate:
a type associated with a connection to a network;
a number of supported component carriers;
a round-trip time; or
a mobility state; or
a computational capability to indicate:
a size of memory allocated for a subnetwork use;
a processing capability associated with a subnetwork use; or
battery energy allocated for a subnetwork use.

7. The method of claim 1, wherein the first management capability report indicates an intent to become the management node.

8. The method of claim 1, further comprises:
identifying a schedule for exchanging management capability reports including a periodicity or a duration; and
generating the first management capability report for transmission in accordance with the schedule.

9. The method of claim 1, wherein said determining to become the management node is based on a deterministic model, a heuristic model, or a machine-learning model.

10. The method of claim 1, wherein the second management capability report is received from a base station.

11. An apparatus comprising:
processor circuitry to:
generate a first management capability report associated with a first node, the first management capability report to be transmitted to a second node;
process a second management capability report associated with the second node; and
determine, based on the first management capability report and the second management capability report, a subnetwork formation control (SNFC) node; and
interface circuitry coupled to the processor circuitry to enable communication.

12. The apparatus of claim 11, wherein the processor circuitry is further to:
construct, based on the first management capability report and the second management capability report, an adjacency matrix representing a network topology.

13. The apparatus of claim 12, wherein the processor circuitry is further to:
update the adjacency matrix periodically or based on detecting an event.

14. The apparatus of claim 11, wherein, to determine the SNFC node the processor circuitry is to:
execute a SNFC selection function; or
generate a request, to be transmitted to the second node, indicating an intent to become the SNFC node.

15. The apparatus of claim 11, wherein to determine the SNFC node includes to determine that the first node is the SNFC node, and wherein the processor circuitry is further to:
determine a management node by executing a management node selection function; and
notify the selected management node about one or more nodes assigned to a subnetwork associated with the selected management node.

16. The apparatus of claim 15, wherein the determination of the management node is based on a network topology map, a device capability, or satisfying a condition.

17. The apparatus of claim 15, wherein the determination of the management node is based on satisfying a condition, wherein the condition is satisfied based on a determination that:
a number of connections to other management nodes meets or exceeds a threshold;
a communication delay with other management nodes is less than a threshold;
a load balancing constraint is met;
a privacy constraint is met; or
a resource constraint is met.

18. The apparatus of claim 15, wherein the first node is the management node, and the processor circuitry is further to:
generate a subnetwork registration request for transmission to a base station;
generate a subnetwork registration confirmation message to be transmitted to the management node; and
generate a subnetwork information message to a subnetwork assigned node.

19. A method comprising:
maintaining a list including a first temporary identifier (ID) of a first user equipment (UE) and a second temporary ID of a second UE, wherein the second UE is a trusted UE of the first UE;
storing a first management node capability of the first UE;
processing a second message of the second UE matching the first temporary ID of the first UE;
generating a first message for transmission to the first UE, including a second management node capability of the second UE;
generating a second message for transmission to the second UE including the first management node capability; and
processing a base station (BS)-aided subnetwork registration request received from the first UE to register a subnetwork.

20. The method of claim 19, further comprising:
generating subnetwork information for transmission to the second node, the subnetwork information indicating registration of the subnetwork or resources assigned to the subnetwork.
